(19) United States
(12) Patent Application Publication
(10) Pub. No.: US 2024/0310518 A1
(43) Pub. Date: Sep. 19, 2024

(54) OBSTACLE DETECTION DEVICE, OBSTACLE DETECTION METHOD, AND COMPUTER-READABLE MEDIUM

(71) Applicant: Panasonic Automotive Systems Co., Ltd., Kanagawa (JP)

(72) Inventors: Hiroki YAMASHITA, Kanagawa (JP); Yiming YANG, Aichi (JP)

(21) Appl. No.: 18/597,225

(22) Filed: Mar. 6, 2024

(30) Foreign Application Priority Data
Mar. 15, 2023 (JP) 2023-040219

(51) Int. Cl. G01S 15/931; G01S 15/87

(52) U.S. Cl. CPC G01S 15/931; G01S 15/878; G01S 2015/934

(57) ABSTRACT

An obstacle detection device includes a plurality of ranging sensors, and a control circuit. The plurality of ranging sensors are disposed on a vehicle at predetermined intervals. The plurality of ranging sensors transmits ultrasonic waves and receives reflected waves of the ultrasonic waves. The control circuit is configured to detect an obstacle around the vehicle based on the reflected waves received by the plurality of ranging sensors. The control circuit includes an adjustment circuit configured to adjust a determination range in a width direction in a determination region of a first ranging sensor located closer to a center of the vehicle in the width direction than another ranging sensor among the plurality of ranging sensors.

### CROSS-REFERENCE TO RELATED APPLICATIONS

This application is based upon and claims the benefit of priority from Japanese Patent Application No. 2023-040219, filed on Mar. 15, 2023, the entire contents of which are incorporated herein by reference.

### FIELD

The present disclosure relates to an obstacle detection device, an obstacle detection method, and a computer-readable medium.

### BACKGROUND

An obstacle detection device is mounted on a vehicle. The obstacle detection device detects an object such as a preceding vehicle, an obstacle, or a pedestrian. The obstacle detection device includes a ranging sensor. As the obstacle detection device, there are known techniques for performing various types of control to improve vehicle driving safety, such as automatic brake activation and notification to a driver, based on the results of object detection by the ranging sensor.

In the obstacle detection device, a plurality of ranging sensors is disposed at intervals in the vehicle width direction. The ranging sensors detect the position of an object by sequentially transmitting ultrasonic waves and receiving reflected waves. However, if there are objects on the left and right in front of the vehicle in the moving direction and the distances from the vehicle to the left and right objects are different, the ranging sensors can detect a ghost position at which no object exists, in addition to the actual positions of the objects. In this case, it is difficult for the obstacle detection device to accurately detect obstacles. In contrast, JP 2016-080644 A, for example, discloses one technique. The technique disclosed in JP 2016-080644 A determines whether an object exists based on reception times of reflected waves received at two different positions.

### BRIEF DESCRIPTION OF THE DRAWINGS

FIG. 1 is a block configuration diagram illustrating an obstacle detection device according to the present embodiment;

FIG. 2 is a plan view illustrating determination regions of sonars mounted on a vehicle;

FIG. 3 is a schematic diagram for explaining a determination range by the obstacle detection device;

FIG. 4 is a flowchart illustrating an obstacle detection method;

FIGS. 5A to 5C are explanatory diagrams for explaining a stop determination state when an object exists on one side;

FIGS. 6A to 6C are explanatory diagrams for explaining a passing determination state when an object exists on one side;

FIGS. 7A to 7C are explanatory diagrams for explaining a stop determination state when objects exist on both sides; and

FIGS. 8A to 8C are explanatory diagrams for explaining a passing determination state when objects exist on both sides.

### DETAILED DESCRIPTION

An obstacle detection device according to an embodiment of the present disclosure includes a plurality of ranging sensors, and a control circuit. The plurality of ranging sensors are disposed on a vehicle at predetermined intervals. The plurality of ranging sensors transmits ultrasonic waves and receives reflected waves of the ultrasonic waves. The control circuit is configured to detect an obstacle around the vehicle based on the reflected waves received by the plurality of ranging sensors. The control circuit includes an adjustment circuit configured to adjust a determination range in a width direction in a determination region of a first ranging sensor located closer to a center of the vehicle in the width direction than another ranging sensor among the plurality of ranging sensors.

Note that comprehensive or specific examples of these may be implemented by a system, a device, a method, an integrated circuit, a computer program, or a recording medium, or may be implemented by any combination of a system, a device, a method, an integrated circuit, a computer program, and a recording medium.

Further advantages and effects in an embodiment of the present disclosure will be apparent from the specification and drawings. Such advantages and/or effects are each provided by several embodiments and features described in the specification and drawings, not necessarily all of which are provided to obtain one or more identical features.

Hereinafter, preferred embodiments of the present disclosure will be described in detail with reference to the drawings. Note that the present disclosure is not limited by the embodiments, and if there is a plurality of embodiments, the present disclosure includes combinations of the embodiments. In addition, the constituent elements in the embodiments include those that can be easily assumed by those skilled in the art, those that are substantially the same, and those are in the so-called equivalent range

### Obstacle Detection Device

An obstacle detection device 10 includes a plurality of (in the present embodiment, four) sonars (ranging sensors) 11, 12, 13, and 14, a driving state detection unit 15, and a control circuit 16.

The sonars 11, 12, 13, and 14 are disposed, for example, at intervals at the rear end of a vehicle 100 in the vehicle width direction. In the present embodiment, the four sonars 11, 12, 13, and 14 are provided, but five or more sonars may be provided.

The sonars 11, 12, 13, and 14 each include a transmission unit and a reception unit. Note that the transmission unit and the reception unit are configured by one microphone, and may function as the transmission unit at the time of transmission and function as the reception unit at the time of reception, or may be configured as a transmission microphone and a reception microphone in which the transmission unit and the reception unit are separated. The transmission unit transmits an ultrasonic wave. The reception unit receives the reflected wave of the ultrasonic wave transmitted by the transmission unit. The sonars 11, 12, 13, and 14 transmit ultrasonic waves rearward from the rear end of the vehicle 100, and receive reflected waves of the ultrasonic waves that collide with an object and are reflected. Here, an object and an obstacles correspond to a control target object such as another vehicle, an obstacle, and a pedestrian, and an object that does not obstruct movement of the vehicle 100, such as an uneven road surface, corresponds to non-control target object and are not included in the obstacle. The sonars 11, 12, 13, and 14 acquire distance information to the object and reflected wave intensity information.

The driving state detection unit 15 is disposed on the vehicle 100. The driving state detection unit 15 acquires information about a vehicle speed, acceleration, deceleration, braking force, steering angle, and the like, as a driving state of the vehicle 100.

The control circuit 16 is disposed on the vehicle 100. The control circuit 16 is connected with the sonars 11, 12, 13, and 14 and the driving state detection unit 15. The control circuit 16 receives the distance information to the object and the reflected wave intensity information acquired by the sonars 11, 12, 13, and 14. The control circuit 16 further receives the information about the vehicle speed, acceleration, deceleration, braking force, steering angle, and the like, as the driving state of the vehicle 100 acquired by the driving state detection unit 15.

The control circuit 16 includes an object detection unit 21, a collision prediction unit 22, and a driving control circuit 23. The object detection unit 21 includes an adjustment circuit 24.

The control circuit 16 detects an obstacle behind the vehicle based on the distance information to the object and the reflected wave intensity information input from the sonars 11, 12, 13, and 14, and the information about the vehicle speed, acceleration, deceleration, braking force, steering angle, and the like of the vehicle 100 input from the driving state detection unit 15 to control the driving of the vehicle 100.

The object detection unit 21 receives the distance information to the object, the reflected wave intensity information, and the information about the vehicle speed, acceleration, deceleration, braking force, and steering angle of the vehicle 100. The object detection unit 21 calculates coordinates and a reliability level of the object based on the distance information to the object and the information about the vehicle speed, acceleration, deceleration, braking force, steering angle, and the like of the vehicle 100. The object detection unit 21 further determines whether the object detected based on the reflected wave intensity information corresponds to the control-target object or the non-control-target object.

The collision prediction unit 22 receives the coordinates and reliability level of the object calculated by the object detection unit 21 and the determination result of the object detection unit 21 as to whether the object corresponds to the control-target object or the non-control-target object. The collision prediction unit 22 further receives the information about the vehicle speed, acceleration, deceleration, braking force, steering angle, and the like of the vehicle 100. The collision prediction unit 22 compares the positions and the motions of the vehicle 100 and the object determined as the control-target object with a preset control determination region to determine whether the vehicle 100 will collide with the object.

The driving control circuit 23 receives the determination result of the collision prediction unit 22 as to whether the vehicle 100 will collide with the object. The driving control circuit 23 controls the driving state of the vehicle 100 based on the determination result of the collision prediction unit 22. The driving control circuit 23 is connected with a drive device 31 and a braking device 32 of the vehicle 100. The drive device 31 moves the vehicle 100 forward and backward, and the braking device 32 stops the vehicle 100. When receiving the determination result that the vehicle 100 will not collide with the object, the driving control circuit 23 drives and controls the drive device 31 of the vehicle 100 to cause the vehicle 100 to move. On the other hand, when receiving the determination result that the vehicle 100 will collide with the object, the driving control circuit 23 drives and controls the braking device 32 of the vehicle 100 to cause the vehicle 100 to stop.

The adjustment circuit 24 adjusts the determination range in the width direction in the determination regions of the sonars 12 and 13 located close to the center (inside) of the vehicle 100 in the width direction among the sonars 11, 12, 13, and 14. The adjustment circuit 24 switches between a wide reference range set by adding a first length to the width of the vehicle 100 and a narrow corrected range set by subtracting a second length from the width of the vehicle 100. The first length and the second length may be the same length or different lengths.

Note that, in the case of four sonars, the sonars 12 and 13 are referred to as a first sonar or first ranging sensor located close to the center (inside) of the vehicle 100 in the width direction, and the sonars 11 and 14 located far from the center (outside) of the vehicle 100 in the width direction are referred to as a second sonar or second ranging sensor. In the case of six sonars, two sonars located close to the center (inside) of the vehicle 100 in the width direction are referred to as a first sonar or first ranging sensor, and the remaining four sonars are referred to as a second sonar or second ranging sensor. Note that the second length may be changed according to the distance measurement result of the first sonars.

The adjustment circuit 24 switches from the reference range to the corrected range when the sonars 12 and 13 located close to the center (inside) of the vehicle 100 in the width direction detect objects on both sides in the moving direction of the vehicle 100. The adjustment circuit 24 adjusts the corrected range based on an offset amount between the center position between the objects on both sides in the moving direction of the vehicle 100 and the center position of the vehicle 100 in the width direction. When the vehicle speed of the vehicle 100 is lower than or equal to a preset low speed, the adjustment circuit 24 may not adjust the determination range.

Note that detailed processing of the adjustment circuit 24 will be described later.

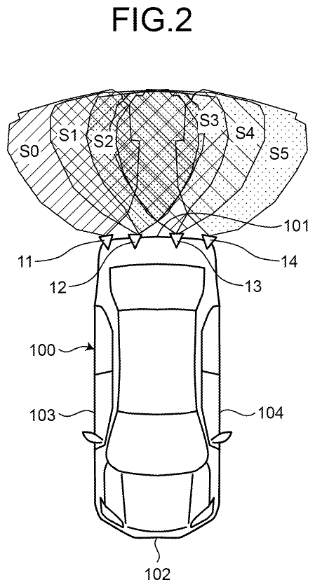

As illustrated in FIG. 2, the sonars 11, 12, 13, and 14 are disposed at intervals in the vehicle width direction at a rear end 101 of the vehicle 100. However, the sonars 11, 12, 13, and 14 may be provided at a front end 102 or left and right sides 103 and 104 in addition to the rear end 101 of the vehicle 100.

Determination regions S0, S1, S2, S3, S4, S5, and S6 are set in the sonars 11, 12, 13, and 14. The determination regions S0, S1, S2, S3, S4, S5, and S6 are transmission regions of ultrasonic waves by the transmission units of the sonars 11, 12, 13, and 14, and are also reception regions of the reception units. The determination regions S0, S1, S2, S3, S4, S5, and S6 are configured by combinations of two sonars 11, 12, 13, and 14 among the sonars 11, 12, 13, and 14.

For example, the determination region S0 is a region in which the position (coordinates) of an object is detected based on a direct wave of the sonar 11 and an indirect wave of the sonar 12. The determination region S1 is a region in which the position (coordinates) of an object is detected based on a direct wave of the sonar 12 and an indirect wave of the sonar 11. The determination region S2 is a region in which the position (coordinates) of an object is detected based on a direct wave of the sonar 12 and an indirect wave of the sonar 13. The determination region S3 is a region in which the position (coordinates) of an object is detected based on a direct wave of the sonar 13 and an indirect wave of the sonar 12. The determination region S4 is a region in which the position (coordinates) of an object is detected based on a direct wave of the sonar 13 and an indirect wave of the sonar 14. The determination region S5 is a region in which the position (coordinates) of an object is detected based on a direct wave of the sonar 14 and an indirect wave of the sonar 13.

Note that, here, direct waves are reflected waves in which the transmission waves transmitted by the transmission units of the sonars 11, 12, 13, and 14 are reflected by an object and received by the reception units of the sonars 11, 12, 13, and 14 themselves that have transmitted the waves. Indirect waves are reflected waves in which the transmission waves transmitted by the transmission units of the sonars 11, 12, 13, and 14 are reflected by an object and received by the reception units of the paired sonars 11, 12, 13, and 14. For example, in the determination region S0, the reception unit of the sonar 11 receives, as a direct wave, a reflected wave of a transmission wave transmitted by the transmission unit of the sonar 11 and reflected by an object. In addition, in the determination region S0, the reception unit of the sonar 12 receives, as an indirect wave, a reflected wave of a transmission wave transmitted by the transmission unit of the sonar 11 and reflected by an object.

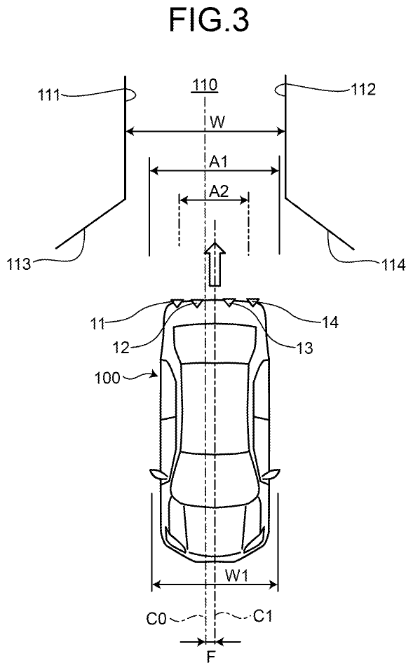

As illustrated in FIG. 3, a case in which the vehicle 100 moves backward and parks in a garage 110 is described. The garage 110 is provided with left and right walls 111 and 112, and inclined surfaces 113 and 114 continuing to the left and right walls 111 and 112 are provided at the entrance. In this case, the width of the garage 110 is W, and the width of the vehicle 100 is W1.

The obstacle detection device 10 detects the position (coordinates) of an object by the sonars 11, 12, 13, and 14, and predicts a collision between the vehicle 100 and the object. When objects exist on the left and right of the vehicle 100 in the moving direction, the obstacle detection device 10 predicts whether the vehicle 100 can pass between the left and right objects based on the positions of the objects by the sonars 11, 12, 13, and 14. For example, the obstacle detection device 10 predicts whether the vehicle 100 can pass between the left and right walls 111 and 112 and park in the garage 110 without colliding with the left and right inclined surfaces 113 and 114 based on the positions of the objects by the sonars 11, 12, 13, and 14.

However, when the inclined surfaces 113 and 114 exist on both sides in the backward direction of the vehicle 100 and a center C1 of the vehicle 100 in the width direction is shifted in the width direction from a center C0 of the garage 110 in the width direction, which generating an offset F, the obstacle detection device 10 detects in some cases that there is an object at a ghost position at which there is actually no object. In this case, the sonars 11, 12, 13, and 14 have the set determination regions S0, S1, S2, S3, S4, S5, and S6 and are more likely to detect a ghost position in the determination regions S2 and S3 located close to the center (inside) of the vehicle 100 in the width direction.

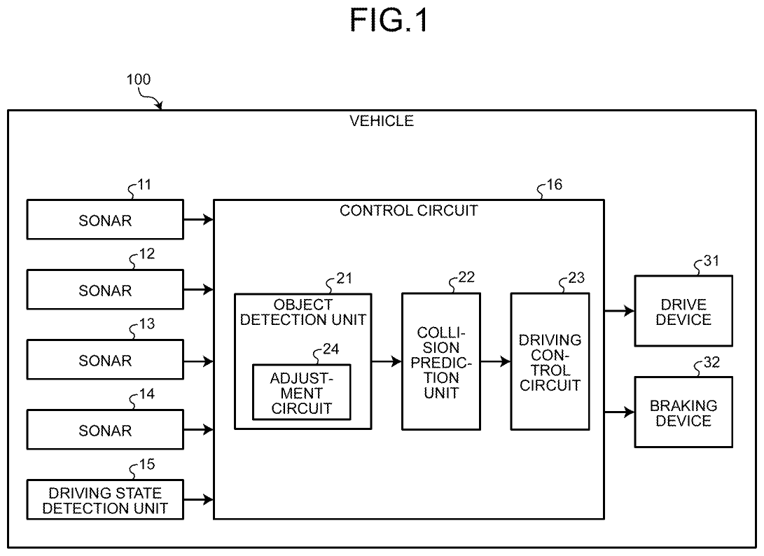

As illustrated in FIGS. 1 and 3, the adjustment circuit 24 has a reference range A1 wider than the width W1 of the vehicle 100 by a predetermined length and a corrected range A2 narrower than the width W1 of the vehicle 100 by a predetermined length. Here, the reference range A1 is set to 105% to 120% of the width W1 of the vehicle 100, and the corrected range A2 is set to 50% to 70% of the reference range A1.

The adjustment circuit 24 may set the reference range A1. The adjustment circuit 24 switches from the reference range A1 to the corrected range A2 when the sonars 12 and 13 located close to the center (inside) of the vehicle 100 in the width direction detect the inclined surfaces 113 and 114 on the left and right of the vehicle 100 in the backward direction. For example, the adjustment circuit 24 adjusts the determination range in the width direction in the determination regions of the sonars 12 and 13 located close to the center (inside) of the vehicle 100 in the width direction among the sonars 11, 12, 13, and 14 to be narrowed.

Note that the adjustment circuit 24 may adjust the corrected range A2 according to the length of the offset F between the center C0 of the garage 110 in the width direction and the center C1 of the vehicle 100 in the width direction. Specifically, when the length of the offset F increases, the adjustment circuit 24 adjusts the width of the corrected range A2 to be narrowed.

In addition, when the speed of the vehicle 100 is low, the obstacle detection device 10 no longer detects a ghost position. Therefore, when the vehicle speed of the vehicle 100 is lower than or equal to a preset low speed, the adjustment circuit 24 may not adjust the determination range. Here, the low speed is 5 km/h.

### Obstacle Detection Method

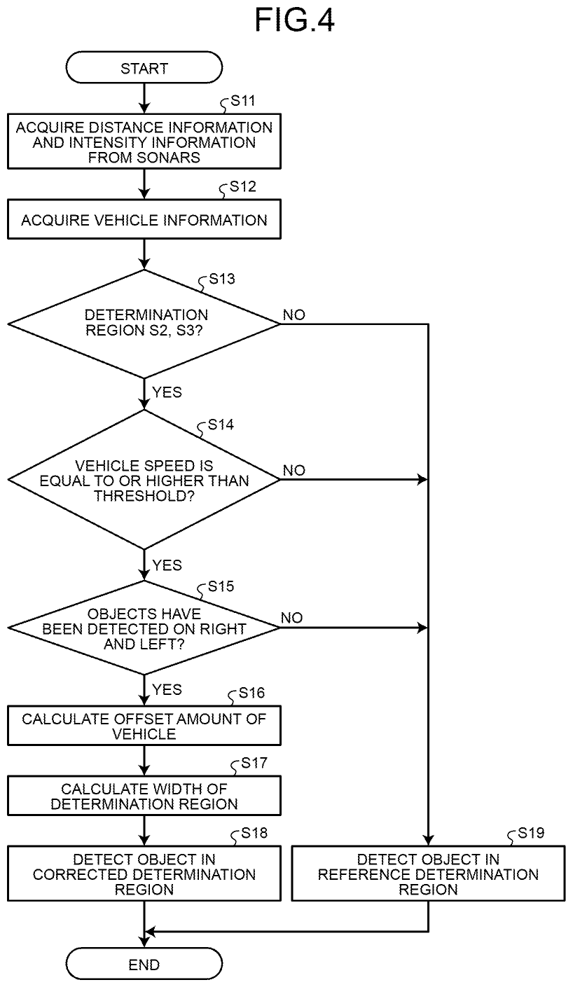

As illustrated in FIGS. 1 and 4, in step S11, the control circuit 16 acquires the distance information and the reflected wave intensity information from the sonars 11, 12, 13, and 14. In step S12, the control circuit 16 acquires the information about the vehicle speed, acceleration, deceleration, braking force, steering angle, and the like of the vehicle 100 from the driving state detection unit 15.

In step S13, the control circuit 16 determines whether the acquired information is about the determination region S2 or S3. Here, when determining that the acquired information is about the determination region S2 or S3 (Yes), the control circuit 16 proceeds to step S14. In step S14, the control circuit 16 determines whether the speed of the vehicle 100 is equal to or higher than a threshold (for example, low speed=5 km/h). Here, when determining that the speed of the vehicle 100 is equal to or higher than the threshold (Yes), the control circuit 16 proceeds to step S15.

In step S15, the control circuit 16 determines whether objects have been detected on the left and right in front of the vehicle 100 in the moving direction. Here, when determining that objects have been detected on the left and right in front of the vehicle 100 in the moving direction (Yes), the control circuit 16 proceeds to step S16. In step S16, the offset amount of the vehicle 100 relative to the left and right objects is calculated. In step S17, the control circuit 16 switches from the reference range A1 to the corrected range A2. Note that the control circuit 16 may adjust the corrected range A2 according to the offset amount. Then, in step S18, the control circuit 16 detects the objects in the corrected range A2 in the determination region S2, S3.

On the other hand, when determining that the acquired information is not about the determination region S2 or S3 (No) in step S13, the control circuit 16 proceeds to step S19. In step S19, the control circuit 16 detects the objects in the reference range A1 in the determination regions S0, S1, S4, and S5. In addition, when determining that the speed of the vehicle 100 is less than the threshold (No) in step S14, and when determining that no object has been detected on the left and right in front of the vehicle 100 in the moving direction (No) in step S15, the control circuit 16 proceeds to step S19 and performs the above processing.

For example, when having detected objects on the left and right in front of the vehicle 100 in the moving direction, the control circuit 16 detects the objects in the corrected range A2 in the determination regions S2 and S3, and detects the objects in the reference range A1 in the determination regions S0, S1, S4, and S5. On the other hand, when having detected no object on the left and right in front of the vehicle 100 in the moving direction, the control circuit 16 detects objects in the reference range A1 in all the determination regions S0, S1, S2, S3, S4, and S5.

### Specific Example of Obstacle Detection Method

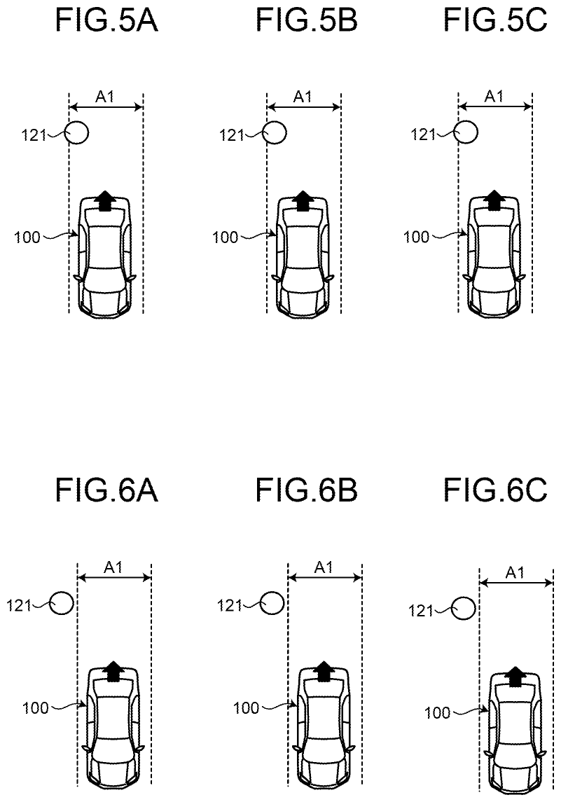

FIGS. 5A to 5C and 6A to 6C are explanatory diagrams for explaining an obstacle detection method when objects do not exist on both left and right sides. FIGS. 5A and 6A explain a detection method in the determination regions S2 and S3, FIGS. 5B and 6B explain a detection method in the determination regions S1 and S4, and FIGS. 5C and 6C explain a detection method in the determination regions S0 and S5.

As illustrated in FIGS. 5A to 5C, when there is an object 121 on the left side of the vehicle 100 in the moving direction, the obstacle detection device 10 applies the reference range A1 in the determination regions S2 and S3, and therefore, can detect the object 121 in the reference range A1 and stop the vehicle. In addition, the obstacle detection device 10 applies the reference range A1 in the determination regions S1 and S4 and in the determination regions S0 and S5, and therefore, can detect the object 121 in the reference range A1 and stop the vehicle. As the result, the obstacle detection device 10 determines that there is an obstacle.

As illustrated in FIGS. 6A to 6C, when the object 121 is on the left side of the vehicle 100 in the moving direction, the obstacle detection device 10 applies the reference range A1 in the determination regions S2 and S3 and does not detect the object 121 in the reference range A1, and the vehicle 100 can pass. In addition, the obstacle detection device 10 applies the reference range A1 in the determination regions S1 and S4 and in the determination regions S0 and S5 and does not detect the object 121 in the reference range A1, and the vehicle 100 can pass. As the result, the obstacle detection device 10 determines that there is no obstacle.

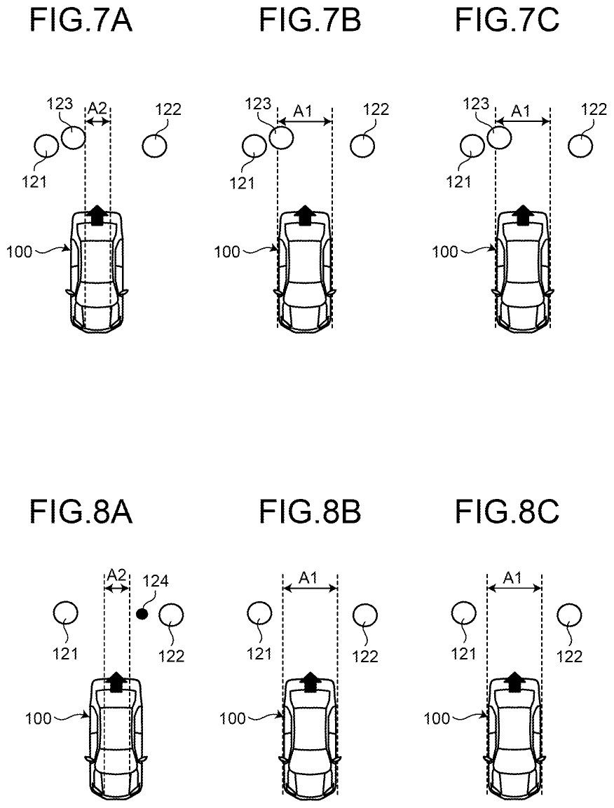

FIGS. 7A to 7C and 8A to 8C are explanatory diagrams for explaining an obstacle detection method when there are objects on both left and right sides. FIGS. 7A and 8A explain a detection method in the determination regions S2 and S3, FIGS. 7B and 8B explain a detection method in the determination regions S1 and S4, and FIGS. 7C and 8C explain a detection method in the determination regions S0 and S5.

As illustrated in FIGS. 7A to 7C, when there are objects 121, 122, and 123 on both sides in the moving direction of the vehicle 100, the obstacle detection device 10 applies the corrected range A2 in the determination regions S2 and S3 and does not detect the object 121 in the corrected range A2, and the vehicle 100 can pass. In addition, the obstacle detection device 10 applies the reference range A1 in the determination regions S1 and S4 and in the determination regions S0 and S5, and therefore, can detect the object 123 in the reference range A1 and stop the vehicle. As the result, the obstacle detection device 10 determines that there is an obstacle.

As illustrated in FIG. 6A to 6C, when the objects 121 and 122 are on both sides in the moving direction of the vehicle 100, the obstacle detection device 10 applies the reference range A1 in the determination regions S2 and S3 and does not detect the objects 121 and 2 in the corrected range A2, and the vehicle 100 can pass. At this time, a ghost object 124 is outside the corrected range A2 and the vehicle 100 can pass. In addition, the obstacle detection device 10 applies the reference range A1 in the determination regions S1 and S4 and in the determination regions S0 and S5 and does not detect the objects 121 and 122 in the reference range A1, and the vehicle 100 can pass. As the result, the obstacle detection device 10 determines that there is no obstacle.

### Effects of Present Embodiment

An obstacle detection device according to a first aspect includes a plurality of sonars (ranging sensors) 11, 12, 13, and 14 that transmits ultrasonic waves, receives reflected waves of the ultrasonic waves, and is disposed on a vehicle 100 at predetermined intervals, and a control circuit 16 that detects an obstacle around the vehicle 100 based on the reflected waves received by the plurality of sonars 11, 12, 13, and 14, in which the control circuit 16 includes an adjustment circuit 24 that adjusts a determination range in a width direction in determination regions S2 and S3 of the sonars (first ranging sensor) 12 and 13 located closer to a center of the vehicle 100 in the width direction than the other sonars 11 and 14 among the plurality of sonars 11, 12, 13, and 14.

With the obstacle detection device according to the first aspect, by adjusting the determination range in the determination regions S2 and S3 of the sonars 12 and 13 located closer to the center (inside) of the vehicle 100 in the width direction among the plurality of sonars 11, 12, 13, and 14, it is possible to improve obstacle detection accuracy without detecting an object at a ghost position.

In an obstacle detection device according to a second aspect, the adjustment circuit 24 switches between a wide reference range A1 set by adding a first length to the width of the vehicle 100 and a narrow corrected range A2 set by subtracting a second length from the width of the vehicle 100. Therefore, by setting the determination range in the determination regions S2 and S3 of the sonars 12 and 13 located closer to the center (inside) of the vehicle 100 in the width direction among the plurality sonars 11, 12, 13, and 14 to the corrected range A2 and the determination range in the determination regions S0, S1, S4, S5, and S6 of the sonars 11 and 14 located outside of the vehicle 100 in the width direction to the reference range A1, it is possible to appropriately detect an actual object in the reference range A1 without detecting an object at a ghost position.

In an obstacle detection device according to a third aspect, the adjustment circuit 24 switches from the reference range A1 to the corrected range A2 when the sonar 12 or 13 located close to the center (inside) of the vehicle 100 in the width direction detects objects on both sides in the moving direction of the vehicle 100. Therefore, it is possible to appropriately detect an actual object in the reference range A1 without detecting an object at a ghost position.

In an obstacle detection device according to a fourth aspect, the adjustment circuit 24 adjusts the corrected range A2 based on an offset amount between a center position between the objects on both sides in the moving direction of the vehicle 100 and a center position of the vehicle 100 in the width direction. Therefore, it is possible to improve erroneous detection accuracy of an object at a ghost position.

In an obstacle detection device according to a fifth aspect, the adjustment circuit 24 may not adjust the determination range when a vehicle speed of the vehicle 100 is lower than or equal to a preset low speed. Therefore, since a ghost position is hardly detected when the vehicle 100 moves at a low speed, it is possible to eliminate unnecessary control and simplify control.

Although not illustrated, a radar device according to an embodiment of the present disclosure includes, for example, a central processing unit (CPU), a storage medium such as a read only memory (ROM) storing a control program, and a working memory such as a random access memory (RAM). In this case, the functions of the units described above are implemented by the CPU executing the control program. However, the hardware configuration of the obstacle detection device is not limited to this example. For example, the functional units of the obstacle detection device may be implemented as an integrated circuit (IC). The functional units may be individually integrated into one chip, or may be integrated into one chip so as to include some or all of the functional units.

Although various embodiments have been described above with reference to the drawings, it is needless to say that the present disclosure is not limited to those examples. It is obvious that a person skilled in the art can conceive various changes or modifications within the scope described in the claims, and it is understood that those changes or modifications naturally belong to the technical scope of the present disclosure. In addition, the constituent elements in the above embodiments may be arbitrarily combined without departing from the gist of the disclosure.

In addition, the term “ . . . unit” in the above embodiments may be replaced with another term such as “ . . . circuitry”, “ . . . assembly”, “ . . . device”, “ . . . unit”, or “ . . . module”.

In each of the above embodiments, the present disclosure has been described as an example of a configuration using hardware, but the present disclosure can also be implemented by software in cooperation with hardware.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. An obstacle detection device comprising:
a plurality of ranging sensors disposed on a vehicle at predetermined intervals, the plurality of ranging sensors transmitting ultrasonic waves and receiving reflected waves of the ultrasonic waves; and
a control circuit configured to detect an obstacle around the vehicle based on the reflected waves received by the plurality of ranging sensors, wherein
the control circuit includes an adjustment circuit configured to adjust a determination range in a width direction in a determination region of a first ranging sensor located closer to a center of the vehicle in the width direction than another ranging sensor among the plurality of ranging sensors.

2. The obstacle detection device according to claim 1, wherein
the adjustment circuit is configured to switch between a reference range wider than a width of the vehicle and a corrected range narrower than the width of the vehicle.

3. The obstacle detection device according to claim 2, wherein
the adjustment circuit is configured to switch from the reference range to the corrected range when the first ranging sensor detects objects on both sides in a moving direction of the vehicle.

4. The obstacle detection device according to claim 2, wherein
the adjustment circuit is configured to adjust the corrected range based on an offset amount between a center position between objects on both sides in a moving direction of the vehicle, and a center position of the vehicle in the width direction.

5. The obstacle detection device according to claim 1, wherein
the adjustment circuit is configured not to adjust the determination range when a vehicle speed of the vehicle is lower than or equal to a preset low speed.

6. An obstacle detection method for an obstacle detection device comprising a plurality of ranging sensors disposed on a vehicle at predetermined intervals, the plurality of ranging sensors transmitting ultrasonic waves and receiving reflected waves of the ultrasonic waves, the obstacle detection method comprising:
adjusting a determination range in a width direction in a determination region of a first ranging sensor located closer to a center of the vehicle in the width direction than another ranging sensor among the plurality of ranging sensors; and
detecting an obstacle around the vehicle based on the reflected waves received by the plurality of ranging sensors.

7. The obstacle detection method according to claim 6, wherein
the determination range is switched to either a reference range wider than a width of the vehicle and a corrected range narrower than the width of the vehicle.

8. The obstacle detection method according to claim 7, wherein
the determination range is switched from the reference range to the corrected range, when the first ranging sensor detects objects on both sides in a moving direction of the vehicle.

9. The obstacle detection method according to claim 7, wherein
the corrected range is adjusted based on an offset amount between a center position between objects on both sides in the moving direction of the vehicle, and a center position of the vehicle in the width direction.

10. The obstacle detection method according to claim 6, wherein
the determination range is not adjusted when a vehicle speed of the vehicle is lower than or equal to a preset low speed.

11. A non-transitory computer-readable medium on which programmed instructions are stored, wherein the programmed instructions, when executed by a computer of an obstacle detection device comprising a plurality of ranging sensors disposed on a vehicle at predetermined intervals, the plurality of ranging sensors transmitting ultrasonic waves and receiving reflected waves of the ultrasonic waves, cause the computer to perform:
adjusting a determination range in a width direction in a determination region of a first ranging sensor located closer to a center of the vehicle in the width direction than the other ranging sensors among the plurality of ranging sensors; and
detecting an obstacle around the vehicle based on the reflected waves received by the plurality of ranging sensors.
